(19) United States
(12) Patent Application Publication
(10) Pub. No.: US 2009/0172024 A1
(43) Pub. Date: Jul. 2, 2009

(54) SYSTEMS AND METHODS FOR COLLECTING AND ANALYZING BUSINESS INTELLIGENCE DATA

(75) Inventors: Shao-Hsin HSU, Hsin-Chu (TW); Chih-Ping Sun, Hsin-Chu (TW); Bo-Hung Lin, Hsin-Chu (TW); Chia-Hui Chen, Hsin-Chu (TW); Yuh-Chiou Tai, Hsin-Chu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 11/967,449

(22) Filed: Dec. 31, 2007

(51) Int. Cl. G06F 17/30

(52) U.S. Cl. 707/104.1; 707/E17.044

(57) ABSTRACT

A system includes a memory to store program code and a processor to execute the program code to perform a process for generating a business intelligence (BI) data presentation. The process includes collecting BI data from one or more data sources and verifying the collected BI data. The process further includes defining an output presentation format in a multidimensional BI database, loading the collected BI data into the multidimensional BI database, refreshing data tables in the multidimensional BI database based on the loaded set of BI data, and generating an output BI data presentation based on the loaded BI data and the output presentation format.

### TECHNICAL FIELD

This disclosure relates generally to managing business intelligence data. More particularly, this disclosure relates to systems and methods for collecting, analyzing, and presenting business intelligence data.

### BACKGROUND

Business Intelligence (“BI”) applications and technologies can enable organizations to make better informed business decisions, and can give a company a competitive advantage. For example, a company could use BI applications or technologies to extrapolate information from indicators in the external environment in order to forecast future trends in their business sector. BI applications may also be used to improve the timeliness and quality of information, enabling managers to better understand the market position of their firm with respect to its competitors.

BI software and applications encompass a range of tools for analyzing data related to business processes. Certain BI applications, such as data mining and data warehousing, document warehousing and document management, knowledge management, and other business data analysis applications, may be used mainly to store and analyze data. Other BI applications can be used to analyze both business performance and internal operations, such as business performance management and measurement, business planning, competitive positioning, supply chain management, and business decision processes.

BI applications and systems may have some latency. For example, BI applications may have data latency, which refers to the time taken to collect and store data. BI applications and systems may also have analysis latency, which refers to the time taken to analyze data and convert it into actionable information. BI applications and systems may further have action latency, which refers to the time taken to react to the actionable information. To implement an effective BI system, it may be desirable to minimize system latency, i.e., to minimize the time from the occurrence of a business event to a corrective action or notification being initiated. Further, for a BI system to be effective, it may be desirable, also important, that different user groups are able to access accurate and timely BI data in appropriate output formats.

Methods and systems consistent with the disclosed embodiments address one or more of the above-mentioned problems.

### SUMMARY OF THE INVENTION

Systems and methods for generating a BI data presentation are disclosed. In one embodiment, the system includes a memory to store program code and a processor to execute the program code to perform a process for generating the BI data presentation. The process includes collecting BI data from one or more data sources and verifying the collected BI data. The process further includes defining an output presentation format in a BI database, loading the collected BI data into the BI database, refreshing data tables in the BI database based on the loaded BI data, and generating an output BI data presentation based on the loaded BI data and the output presentation format.

### BRIEF DESCRIPTION OF THE DRAWINGS

The accompanying drawings, which are incorporated in and constitute a part of this specification, illustrate exemplary embodiments and, together with the description, serve to explain these disclosed embodiments. In the drawings:

FIG. 1A is a block diagram of an exemplary business intelligence data presentation (“BIDP”) system consistent with certain disclosed embodiments;

FIG. 1B is a block diagram of an exemplary web/application server consistent with certain disclosed embodiments;

FIG. 2 is a flow chart of an exemplary process for collecting, analyzing, and presenting BI data consistent with certain disclosed embodiments;

FIG. 3 is a flow chart of an exemplary process for collecting BI data consistent with certain disclosed embodiments;

FIG. 4 is a flow chart of an exemplary process for verifying BI data consistent with certain disclosed embodiments;

FIG. 5A is a flow chart of an exemplary process for indexing BI data consistent with certain disclosed embodiments;

FIG. 5B is an exemplary BI data presentation format consistent with certain disclosed embodiments;

FIG. 6 is a flow chart of an exemplary process for converting BI data consistent with certain disclosed embodiments;

FIG. 7 is a flow chart of an exemplary process for presenting BI data consistent with certain disclosed embodiments;

FIG. 8 is an exemplary data model used in the process of analyzing and presenting BI data consistent with certain disclosed embodiments; and

FIG. 9 is an exemplary BI data presentation consistent with certain disclosed embodiments.

### DETAILED DESCRIPTION

Reference will now be made in detail to the disclosed exemplary embodiments, examples of which are illustrated in the accompanying drawings. Wherever possible, the same reference numbers will be used throughout the drawings to refer to the same or like parts.

Methods and systems consistent with the disclosed embodiments may relate to a BI system for creating one or more presentations of BI data. BI data may be any type of data that provides information related to one or more business processes and/or one or more business transactions. A BI data record may include patent-related data. For example, a granted U.S. patent may be saved as a BI data record. A BI data record may also include other technical/business data. For example, a BI data record may include a paper published in a technical journal.

A BI data presentation may refer to a set of BI data presented in a specific format. For example, a set of BI data may be presented in a tabular format, such as a spreadsheet. A BI data presentation may also be a chart, such as a bar chart or a pie chart, based on a set of BI data. Applications of the disclosed embodiments, however, are not limited to any particular type or format of BI data presentation.

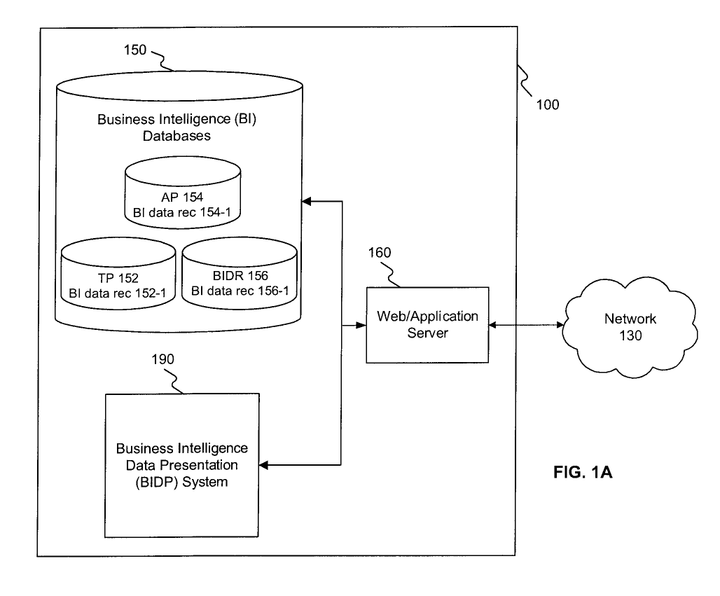

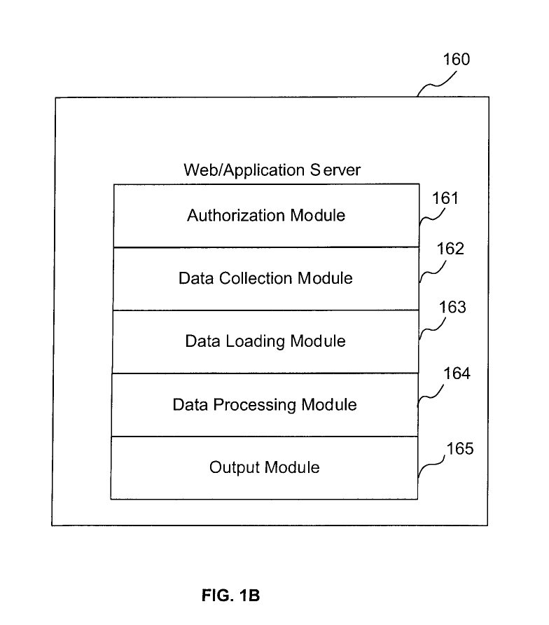

FIG. 1A is a block diagram illustrating a BIDP architecture 100 consistent with certain disclosed embodiments. As shown in FIG. 1, a BIDP architecture 100 may include a web/application server 160, BI databases 150, and a BIDP system 190. Web/application server 160 interfaces with a network 130. Web/application server 160 may also be connected to BI databases 150, and BIDP system 190. It is contemplated that BIDP architecture 100 may include additional or fewer components than those shown in FIG. 1A.

BIDP architecture 100 may be a computer system including hardware/software that enables collaboration among users of BIDP architecture 100, such as one or more data analysts or business managers. In one exemplary embodiment, a data analyst may be responsible for generating one or more charts or spreadsheets based on BI data stored in BI databases 150. BI data may reflect information related to patents as well as other business or technical subject matters.

A user of BIDP architecture 100 may be any individual, software application, and/or system that uses the features of BIDP architecture 100. A user of BIDP architecture 100 may generate, maintain, update, delete, and present BI data records and BI data change entries in BI databases 150. A BI data record may include any data related to creating and presenting a BI data presentation, such as a data table populated with BI data, processed by BIDP architecture 100.

Each component of BIDP architecture 100 may exchange data via network 130. Network 130 may be the Internet, a wireless local area network (LAN), or any other type of network. Thus, network 130 may be any type of communications system. Each user of BIDP architecture 100 may provide inquiries or respond to inquiries using network 130.

BI databases 150 may be a database system and/or software executed by a processor that is configured to store data records, entries for changes made to the data records, and other information used by users of BIDP architecture 100. In one embodiment, BI databases 150 may include three databases: a Transaction Processing (“TP”) database 152, an Analysis Processing (“AP”) database 154, and a BI data record (“BIDR”) database 156. BI data records 152-1, 154-1, and 156-1 may be stored in TP database 152, AP database 154, and BIDR database 156, respectively. TP database 152 may be a relational database. AP database 154 may be a database containing temporary data tables which mirror the data tables in BIDR database 156. BIDR database 156 may be a multidimensional database with at least one fact table and one dimension table.

A multidimensional database refers to a database with various data aggregations which are calculated based on data dimensions. A dimension may be any attribute of a unit of BI data or any relationship between two units of BI data. A multidimensional database may include one or more fact tables. Each fact table may correspond to one or more dimension tables. A fact table in a multidimensional database provides data field values that act as independent variables by which dimensional attributes (i.e., dimensions) of BI data are analyzed. A dimension table provides data field values based on one or more attributes of the BI data stored in the fact table. A dimension may be a data field of the fact table. A user of the multidimensional database may aggregate independent facts (data) based on one or more dimensions. The user may generate one or more BI data presentations with insights to the BI data at a higher level of aggregation based on one or more dimensions.

In one exemplary embodiment, TP database 152 may store one or more BI data records 152-1. BI data records 152-1 may include information describing one or more patents or patent applications. For example, BI data record 152-1 may include information such as the patent number, the filing date, the inventor names, etc., of a patent. BI data records 152-1 may also include information defining a family of products, such as the model numbers for a group of products, the technology standards corresponding to the products, etc.

BIDR database 156 may include a fact table A with data defining companies with patents and products in a specific technical area. One dimension for the BI data stored in BIDR database 156 may be product family. A product family may refer to any group of products having a common classification criterion. For example, a product family may refer to a group of products designed based on the same technical standard. BIDR database 156 may include a dimension table which contains the dimensions corresponding to product families and product names. The dimension table may be named “product family table.” A first column of the product family table may contain product names of products which were previously sold in the market. A second column of the product family table may contain product names of the successor products to the products listed in the first column.

AP database 154 may contain temporary data tables which mirror the data tables in BIDR database 156. The temporary tables in AP database 154 may have the same structures as their counterparts in BIDR database 156. For example, AP database 154 may include a temporary fact table A and a temporary product family table. The temporary fact table A and product family table in AP database 154 may have the same structures as the fact table A and the product family table in BIDR database 156. The relationships among TP database 152, AP database 154, and BIDR database 156 will be described in more detail in relation to web/application server 160 and BIDP system 190 below.

Web/application server 160 may include an interface that allows users to access and edit data records in BI databases 150 and BIDP system 190. FIG. 1B illustrates an exemplary web/application server 160 consistent with certain disclosed embodiments. As shown in FIG. 1B, a web/application server 160 may include an authorization module 161, a data collection module 162, a data loading module 163, a data processing module 164, and an output module 165.

Authorization module 161 may manage the access levels for users of BIDP architecture 100. For example, authorization module 161 may store a rule which indicates that a first user may be allowed to access all data records in BI databases 150 while a second user may be allowed only to access a portion of the data records in BI databases 150. As such, upon detecting the user ID of a user, authorization module 161 may authorize the user to access only a portion of BI data in BI databases 150 based on the user ID.

Data collection module 162 may receive BI data entries from a user of BIDP architecture 100. For example, a user may run a script to load a data file into TP database 152. Data collection module 162 may also collect BI data from a data source, such as another software application or a website. A data source may be any data site (e.g., a database or a text file) where data are stored and may be obtained. Data collection module 162 may also use a program or automated script, such as a web crawler, to browse the internet through network 130 in a methodical and/or automated manner. Data collection module 162 may collect BI data from the internet or any other network. In one embodiment, data collection module 162 may visit one or more web pages, copying data for later processing by web/application server 160 and BIDP system 190. Data collection module 162 may store the collected data (e.g., data copied from web pages) as BI data records 152-1 in TP database 152 (FIG. 1A).

Data loading module 163 may apply one or more rules or parsing algorithms to the collected BI data in TP database 152 to derive the data to be loaded into AP database 154. For example, data loading module 163 may select only certain columns of a collected BI data record 152-1 in TP database 152 to load into AP database 154. Data loading module 163 may map BI data records 152-1 stored in TP database 152 into data tables in AP database 154, which mirror the data tables in BIDR database 156.

When populating data tables of AP database 154, data loading module 163 may also translate and/or encode data field values. For example, if the BI data collected from a data source has a date format of “DD/MM/YY,” but BIDR database 156 stores date in the “DD/MM/YYYY” format, data loading module 163 may convert the collected data from TP database 152 into the BIDR database 156 format when loading the BI data records 152-1 into AP database 154.

Data loading module 163 may further join together BI data records 152-1 from multiple data sources into one BI data record 154-1, summarize multiple rows of data, transposing or pivoting (turning multiple columns into multiple rows or vice versa), and split a column into multiple columns (e.g., putting a comma-separated list specified as a string in one column as individual values in different columns), etc. After loading BI data records 152-1 into AP database 154, data loading module 163 may save the loaded data as BI data records 154-1. After loading BI data from TP database 152 into AP database 154, data loading module 163 may copy the BI data records 154-1 from AP database 154 into BIDR database 156.

Data processing module 164 may further process the BI data loaded by data loading module 163 into BIDR database 156. As explained earlier, BIDR database 156 may contain at least one fact table and one or more dimension tables. After BI data records 156-1 are loaded into BIDR database 156, data processing module 164 may refresh one or more fact tables and dimension tables to fully incorporate the newly loaded BI data into all data tables. For example, because of the newly loaded data, additional records in a dimension table may need to be populated.

In the example of the product family table, the newly loaded BI data may include new product names. As discussed earlier, a first column of the product family table may contain product names of products which were previously sold in the market. A second column of the product family table may contain product names of the successors to the products listed in the first column. Data processing module 164 may thus refresh the product family table to incorporate the new product names so that the newly loaded product names are linked to the corresponding predecessor and/or successor product names.

After web/application server 160 collects, loads, and processes BI data, output module 165 may then generate a BIDP, such as a data table, using a specific format defined by the user or by BIDP system 190. Output module 165 may generate a BIDP upon a request by a user of BIDP architecture 100. Alternatively, output module 165 may generate a BIDP according to one or more default rules.

Returning to FIG. 1A, web/application server 160 may also include additional components, such as software communication tools that permit collaboration amongst users of BIDP architecture 100, bulletin boards to permit users to communicate with each other, and/or search engines to provide efficient access to specific entries in BI databases 150 or BIDP system 190. In one embodiment, web/application server 160 may be the Apache HTTP Server from the Apache Software Foundation, IBM WebSphere, or any other web/application server known in the art.

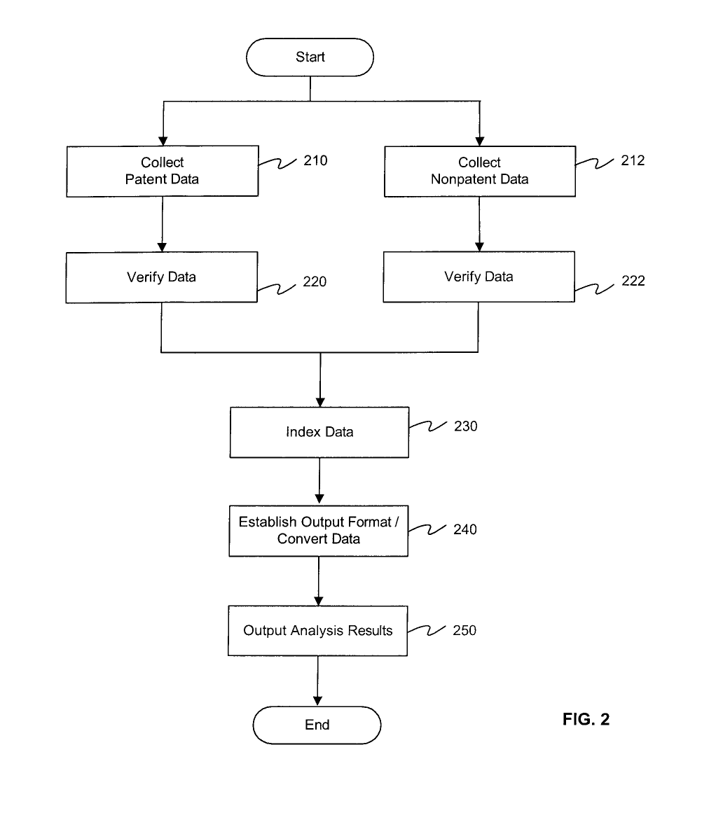

BIDP system 190 may be a computer system or software executed by a processor that is configured to provide access to data records stored in a number of different formats, such as a word processing format, a tabular format, a numerical format, and the like. BIDP system 190 may facilitate capture of BI data records 152-1 and changes to BI data records 152-1, such as data mapping or transformation, by hosting a process that facilitates the activities of users of BIDP architecture 100 through web/application server 160. BIDP system 190 may also use web/application server 160 to enable users of BIDP architecture 100 to create, update, and delete BI data records 152-1, 154-1, and 156-1. A user may use BIDP system 190 to generate one or more BIDPs, such as a data table or a bar chart. FIGS. 2-9 further describe an exemplary process for generating BIDPs in BIDP architecture 100.

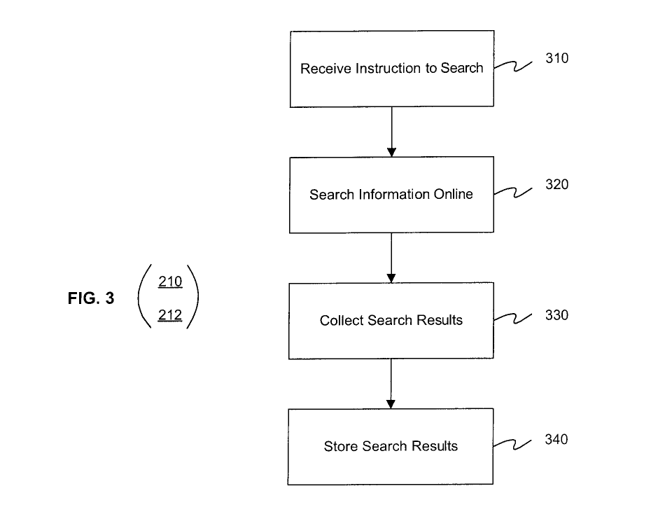

FIG. 2 illustrates an exemplary process of generating a BIDP consistent with certain disclosed embodiments. As shown in FIG. 2, in one embodiment, BIDP system 190 may first collect BI data, such as patent-related data, from various data sources (step 210). FIG. 3 further illustrates a detailed exemplary process for collecting BI data consistent with certain disclosed embodiments.

As shown in FIG. 3, in one embodiment, a user of BIDP architecture 100 may request BIDP system 190 to search the internet to obtain BI data related to patents covering a specific technical area. For example, the user may request that BIDP system 190 search for granted U.S. patents in technical area A. After receiving the search request (step 310), BIDP system 190 may then proceed to search for data related to granted U.S. patents in technical area A (step 320). BIDP system 190 may find a number of web pages which contain data related to granted U.S. patents in technical area A. BIDP system 190 may collect the search results by copying data from the identified web pages (step 330). BIDP system 190 may store the collected data as BI data records 152-1 in TP database 152 (step 340).

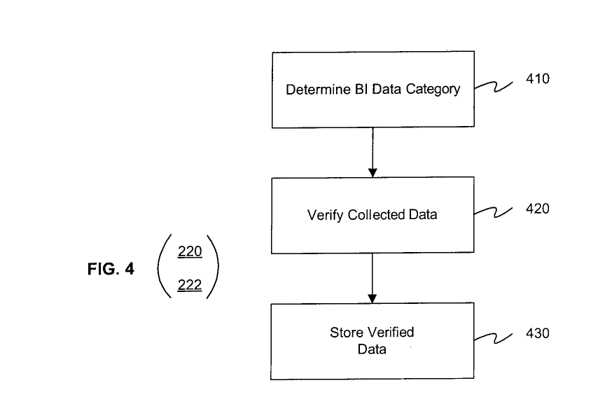

Returning to FIG. 2, after loading the requested patent-related BI data into TP database 152, BIDP system 190 may verify the collected BI data (step 220). FIG. 4 illustrates a detailed exemplary process for verifying BI data consistent with certain disclosed embodiments. As shown in FIG. 4, BIDP system 190 may first determine the category of the collected BI data (step 410). In the example of the requested data related to granted U.S. patents in technical area A, BIDP system 190 may determine that the collected BI data are patent-related data, which may be one category of BI data.

Next, BIDP system 190 may verify the collected BI data based on the determined category (step 420). In the example of the requested data related to granted U.S. patents in technical area A, BIDP system 190 may apply the verification rules corresponding to the “patent-related data” category. For example, BIDP system 190 may verify that in the collected patent-related data, there exists a filing date corresponding to each patent number. Further, BIDP system 190 may verify that the filing date is in one of the specified date formats, such as “DD/MM/YY” or “DD/MM/YYYY.” Similarly, BIDP system 190 may verify that in the collected patent-related data, there is at least one inventor name for each patent number. BIDP system 190 may verify that an inventor name is in a text format. If BIDP system 190 finds one or more data errors in the verification process, BIDP system 190 may prompt a user of BIDP architecture 100 to correct the identified data errors or reload the BI data into TP database 152 through a graphical user interface. After verifying the collected BI data based on the determined category, BIDP system 190 may store the BI data in TP database 152 (step 430).

Returning to FIG. 2, similar to the process of collecting and verifying patent related data in steps 210 and 220, BIDP system 190 may also collect other technical/business-related BI data (step 212) and verify the other technical/business-related BI data (step 222). For example, the user of BIDP architecture 100 may also request that BIDP system 190 locate data of other technical publications (excluding patents) such as journal papers or user manuals, covering technical area A. FIGS. 3 and 4 also illustrate detailed processes of loading and verifying other technical/business-related BI data consistent with certain disclosed embodiments.

As shown in FIG. 3, in one embodiment, a user of BIDP architecture 100 may request BIDP system 190 to search the internet to obtain BI data not related to patents. For example, the user may request BIDP system 190 to search for technical/business publications in technical area A. Upon receiving the search request (step 310), BIDP system 190 may proceed to search for data related to technical/business publications in technical area A (step 320). BIDP system 190 may find a number of web pages which contain data related to technical/business publications in technical area A. BIDP system 190 may collect the search result by copying data from the identified web pages (step 330). BIDP system 190 may load the collected data related to technical/business publications in technical area A as BI data records 152-1 into TP database 152 (step 340).

As shown in FIG. 4, to verify the collected BI data loaded into TP database 152, BIDP system 190 may first determine the category of the collected BI data (step 410). In the example of the requested technical/business publications in technical area A, BIDP system 190 may determine whether the collected BI data belong to one of the data categories, such as “patent litigation data,” “intellectual asset management data,” “financial data,” “merger and acquisition data,” etc. Next, BIDP system 190 may verify the collected BI data based on the determined categories (step 420).

For example, BIDP system 190 may determine that one piece of the collected technical/business BI data is related to a company's financial report, such as a 10K report (an annual report required by the U.S. Securities and Exchange Commission). BIDP system 190 may then verify that there is a filing date corresponding to the 10K report. Further, BIDP system 190 may verify that the filing date is in one of the specified date formats, such as “DD/MM/YY” or “DD/MM/YYYY.” Similarly, BIDP system 190 may verify that in the 10K report, there exists a filing company name. BIDP system 190 may verify that the company name is in a text format.

If BIDP system 190 finds one or more errors in the verification process, BIDP system 190 may prompt the user of BIDP architecture 100 to enter corrections for the identified data errors or reload the data record. After verifying the collected BI data based on the categorization, BIDP system 190 may store the BI data in TP database 152 (step 430).

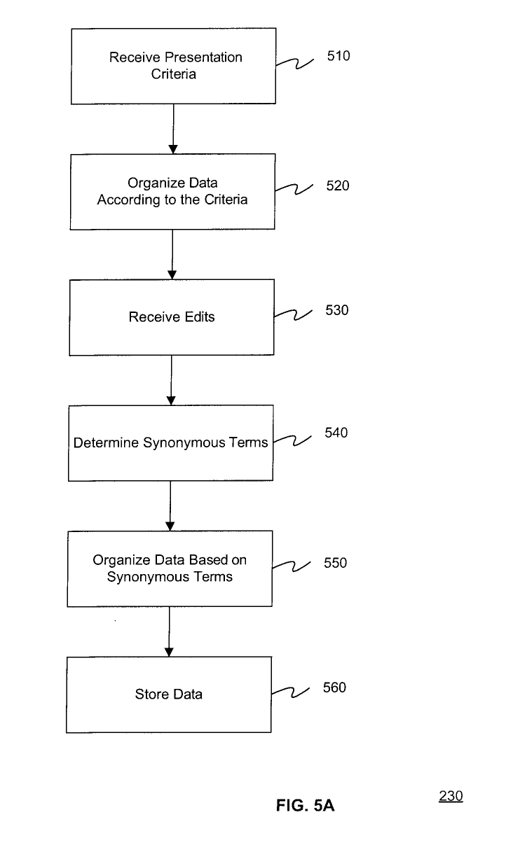

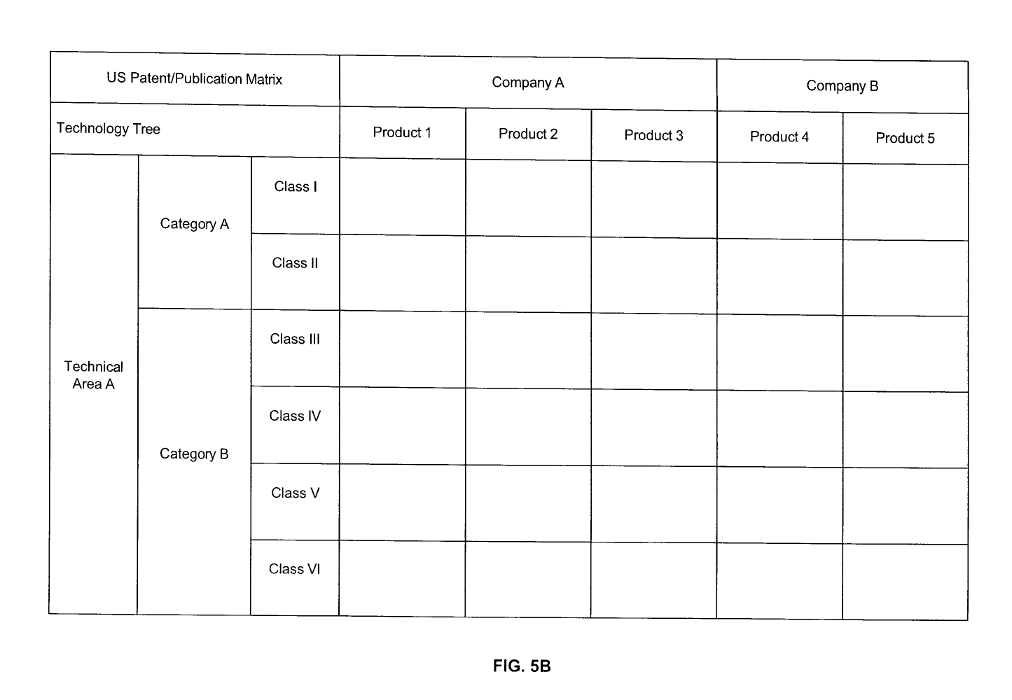

Returning to FIG. 2, after loading and verifying patent-related and other technical/business-related BI data in steps 210, 220, 212, and 222, BIDP system 190 may index the collected BI data (step 230). FIG. 5A illustrates a detailed exemplary process of indexing BI data consistent with certain disclosed embodiments.

As shown in FIG. 5A, BIDP system 190 may first receive presentation criteria from the user of BIDP architecture 100 (step 510). A presentation criterion may be any attribute or characteristic related to BI data which the user selects for presentation of the BI data. For example, if the user requests that BIDP system 190 generate an output data table, the user may enter the data fields corresponding to the rows and columns of the data table as the presentation criteria. FIG. 5B shows an exemplary output BIDP consistent with certain disclosed embodiments.

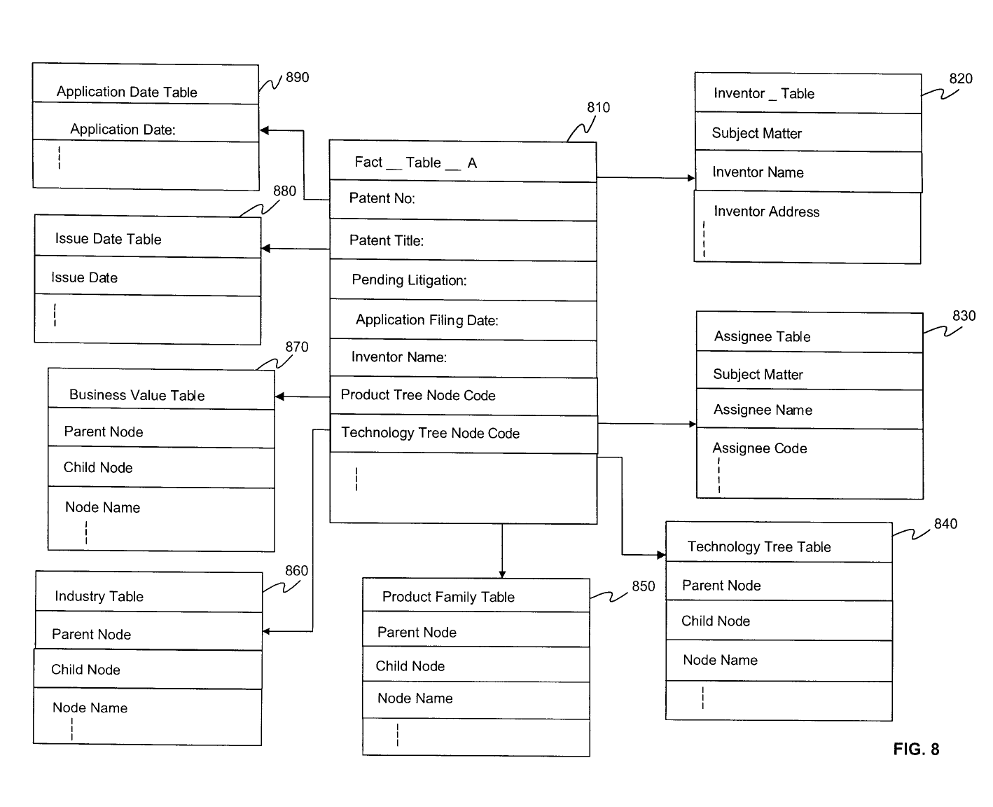

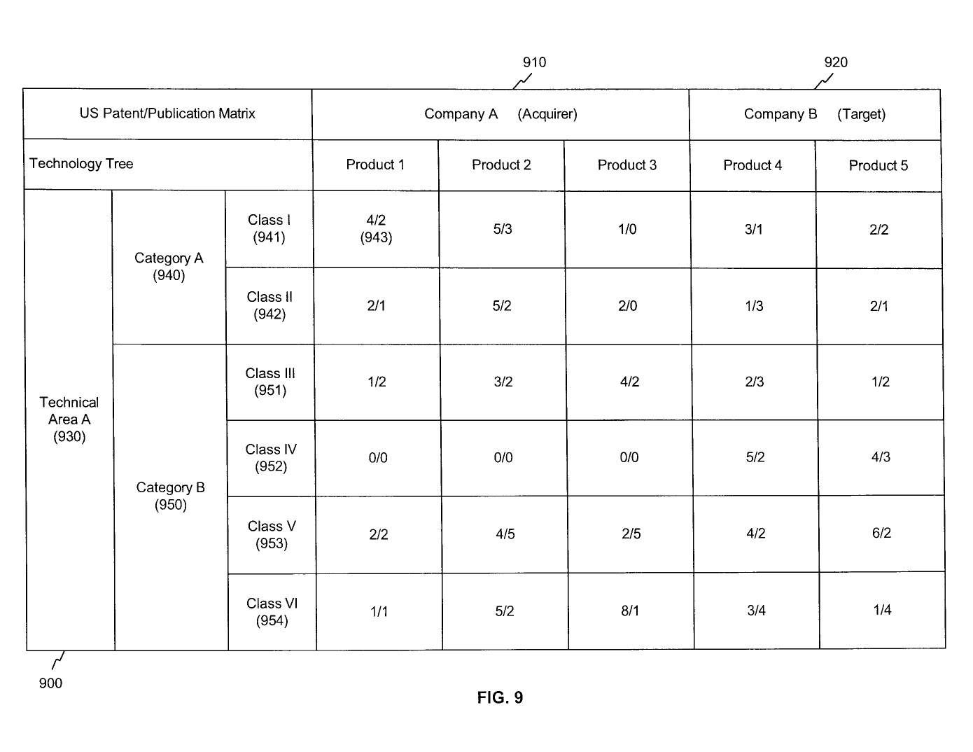

As shown in FIG. 5B, the user of BIDP architecture 100 may request that BIDP system 190 generate a data table displaying patents and other technical/business publications for company A and company B covering their products in technical area A. In step 510, the user may define “company name” as a presentation criterion. BIDP system 190 may then search for company names in the collected BI data stored in TP database 152. The BIDP as shown in FIG. 5B is further described in detail in relation to FIGS. 8 and 9.

Returning to FIG. 5A, BIDP system 190 may organize the BI data in TP database 152 based on the presentation criteria received. BIDP system 190 may present the organized BI data to the user through a user interface (step 520). In the example of BI data collected for technical area A, the user may specify that one presentation criterion is “company name.” BIPD system 190 may thus organize all BI data records 152-1 collected and loaded in steps 210, 212, 220 and 222 (FIG. 2) based on “company name.” BIDP system 190 may present to the user through a user interface the list (i.e., an index) of company names with links to the related BI data records 152-1. The user may edit the BI data presented (e.g., data in the company name data field). BIDP system 190 may receive and save the BI data with the edits in TP database 152 (step 530).

Next, BIDP system 190 may select synonymous terms for data values related to one or more presentation criteria (step 540). In the example of BI data collected for technical area A, the user may specify that one selection criterion is company name. For example, “Microsoft Corporation” may be one of the company names from the collected BI data records 152-1. BIDP system 190 may then select “MSFT” and “Microsoft Inc.” as synonymous terms of “Microsoft Corporation.” BIDP system 190 may present the selected terms, “MSFT” and “Microsoft Inc.”, to the user through a graphical user interface. The user may determine that either or both terms are synonymous terms. BIDP system 190 may then associate the determined synonymous terms (“MSFT” and/or “Microsoft Inc.”) to the original data value (“Microsoft Corporation”).

After associating the synonymous terms, BIDP system 190 may further organize the BI data based on the selected synonymous terms (step 550). In the example of “Microsoft Corporation,” BIDP system 190 may further search for company names using “MSFT” and “Microsoft Inc.” in the collected BI data stored in TP database 152. BIDP system 190 may find occurrences of “MSFT” or “Microsoft Inc.” in the BI data. BIDP system 190 may reorganize the “company name” list to include the newly identified occurrences of other Microsoft Corporation designations. BIDP system 190 may present the reorganized BI data to the user through a graphical user interface. Finally, BIDP system 190 may index the collected BI data based on the presentation criterion and its synonymous terms, and store the edited and reorganized BI data in TP database 152.

In other embodiments, instead of receiving a presentation criterion, BIDP system 190 may parse and extract one or more keywords, such as “company name,” from the collected BI data by applying one or more text classification methods. For example, BIDP system 190 may apply a Support Vector Machine (SVM) or Kth Nearest Neighbor (KNN) based text categorization/classification method to parse out relevant words and terms in the collected BI data.

In another example, BIDP system 190 may also apply one or more methods for content analysis, which may reveal textual information and systematical properties of the collected BI data. For example, BIDP system 190 may determine the subject matter area of the collected BI data based on the frequencies of most used keywords in the collected BI data.

BIDP system 190 may apply one or more SVM or KNN based method as well as one or more content analysis methods in determining keyswords related to one or more presentation criteria. BIDP system 190 may also apply one of more of these methods in the process of associating synonymous terms to the keywords, and in the process of organizing the collected BI data based on the keywords and synonymous terms. BIDP system 190 may then utilize one or more extracted keywords and related synonymous terms to form one or more presentation criteria. For example, a presentation criterion may be based on one or more keywords with associated weights.

After identifying and determining one or more presentation criteria based on one or more keywords, BIDP system 190 may index the collected BI data based on the presentation criteria, and store the indexed BI data in TP database 152.

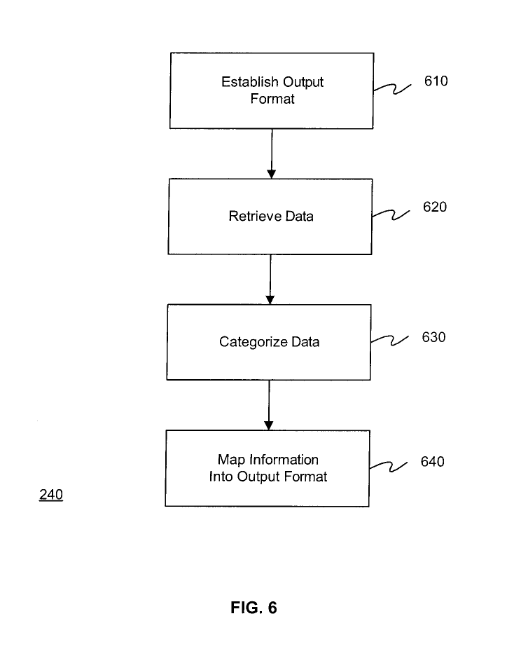

Returning to FIG. 2, after indexing the collected BI data, BIDP system 190 may then establish an output format for the BIDP (step 240). FIG. 6 illustrates a detailed process for establishing an output BIDP format consistent with certain disclosed embodiments.

As shown in FIG. 6, BIDP system 190 may establish an output format by defining data tables and data fields in data tables of BIDR database 156 (step 610). In one embodiment, one presentation criterion may correspond to one or more data fields in a data table of BIDR database 156. For example, BIDP system 190 may determine that the BIDP output may display a hierarchical structure, such as a product family tree with each product name being a node of the tree structure. The tree structure may have one root node with no parent node, and one or more other nodes with parent and child nodes. BIDP system 190 may verify that BIDR database 156 and AP database 154 each contain one or more data tables supporting the output format of a product family tree.

In one embodiment, BIDP system 190 may define a product family table in BIDR database 156 with data describing product names and hierarchical relationships among the products. For example, BIDP system 190 may define a product family table with a column for product name, a column for parent product name, and another column for child product name, etc. BIDP system 190 may duplicate the same product family table definition in AP database 154.

Next, BIDP system 190 may retrieve BI data from TP database 152 for further processing (step 620). Based on the one or more data fields corresponding to the output format (e.g., product name), BIDP system 190 may categorize BI data (step 630). In the example of BI data collected for technical area A, the output format requires that BI data be sorted by company name. BIDP system 190 may thus categorize all BI data records 152-1 collected according to company names. BIDP system 190 may also include the synonymous terms defined for one or more company names and extract the synonymous names.

BIDP system 190 may then map the collected BI data (and/or the related documents) into the identified output format (step 640). As explained above, the output format is defined by one or more data tables and data fields in BIDR database 156 (which are mirrored in AP database 154). After organizing BI data according to the data fields corresponding to the output format, BIDP system 190 may thus map the collected BI data into the data fields of one or more data tables.

In the example of BI data collected for technical area A, after organizing the BI data according to company name, BIDP system 190 may map the collected BI data records 152-1 into the temporary product family table in AP database 154. After loading BI data records 152-1 into AP database 154, BIDP system 190 may copy BI data records 154-1 of AP database 154 into BIDR database 156.

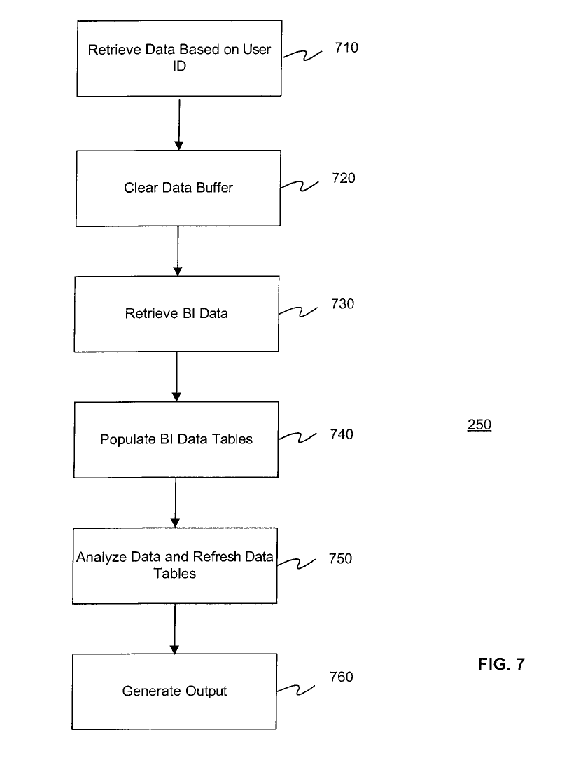

Returning again to FIG. 2, after establishing the output format and converting collected BI data into data records of AP database 154 and BIDR database 156, BIDP system 190 may provide real time analysis and presentation capabilities to users of BIDP architecture 100 (step 250). FIG. 7 illustrates a detailed exemplary process for analyzing and presenting BI data consistent with certain disclosed embodiments.

As shown in FIG. 7, upon detecting a user ID, BIDP system 190 may first retrieve BI data records 156-1 from BIDR database 156 based on the user ID (step 710). For example, a first user of BIDP architecture 100 may be associated with a first set of BI data records 156-1. Upon detecting that the first user entered the request to analyze BI data, BIDP system 190 may then retrieve the first set of BI data.

Next, to ensure that a user accesses a correct set of BI data, BIDP system 190 may delete from the data buffer any data from previous processes (step 720). In the example of the first user accessing the first set of data, BIDP system 190 may delete any previous BI data stored in the temporary data tables of AP database 154 for other users.

BIDP system 190 may then retrieve the latest non-converted BI data records 152-1 from TP database 152 based on the user ID (step 730). In the example of the first user, BIDP system 190 may have conducted a new search (which may be based on the first user's profile or his last search request) on the internet and collected additional BI data records 152-1 after the last batch of BI data had been mapped and loaded into AP database 154. The newly collected BI data records 152-1 have not yet been mapped into AP database 154 or BIDR database 156. BIDP system 190 may then retrieve these unprocessed BI data records 152-1.

BIDP system 190 may map the new BI data records 152-1 into data tables of AP database 154 (step 740). The process of mapping the new BI data records 152-1 has been described above in relation to FIG. 6. As explained earlier, data tables in AP database 154 mirror those in BIDR database 156. FIG. 8 further illustrates an exemplary multidimensional data model implemented in BIDR database 156 consistent with certain disclosed embodiments.

As shown in FIG. 8, in one embodiment, BIDR database 156 may include a fact table 810 and multiple dimension tables such as dimension tables 820-890. Fact table 810 may contain facts or measures and foreign keys which refer to primary keys in dimension tables 820-890. Dimension tables 820-890 may contain attributes used to constrain and group BI data when performing data queries. AP database 154 may include temporary data tables with the same structures as data tables 810-890.

BIDP system 190 may retrieve BI data records 152-1 and extract data needed to populate temporary dimension tables in AP database 154. In the example of the BI data for technical area A, BIDP system 190 may populate the temporary table corresponding to dimension 820 with data values in subject matter, inventor name, inventor address, and other data fields, based on the collected patent related BI data (FIG. 2, step 210). Similarly, BIDP system 190 may populate the temporary tables corresponding to dimension tables 830-890 based on the collected patent related and other technical/business related BI data. BIDP system 190 may also populate the temporary table corresponding to fact table 810 in AP database 154 based on the collected patent related and other technical/business-related BI data.

Once all additional BI data records 152-1 have been mapped into temporary data tables in AP database 154, BIDP system 190 may load BI data records 154-1 into BIDR database 156. This ensures that BIDR database 156 contains the most recent BI data collected by BIDP system 190.

Referring back to FIG. 7, next, BIDP system 190 may analyze the newly loaded BI data records (from AP database 154) and further fill out data fields in dimension tables, such as tables 820-890 in FIG. 8, in BIDR database 156. BIDP system 190 may further update AP database 154 with the newly derived BI data (step 750). For example, in FIG. 8, product family table 850 may include data reflecting a hierarchy (product tree) of the products in technical area A. In table 850, a parent product may be a predecessor product to a child product. The newly loaded BI data in BIDR database 156 (in step 740) may add new product names to product family table 850. BIDP system 190 may thus populate additional data fields in product family table 850 to reflect relationships (e.g., predecessor/successor) between a newly loaded product and any of the product names already in product family table 850.

After BIDP system 190 derives and populates the additional data fields, BIDP system 190 may further refresh AP database 154 to include the additional data values from BIDR database 156. Thus, if a first user of BIDP architecture 100 shares access to AP database 154 with a second user, both users may access the most accurate BI data in AP database 154.

Returning to FIG. 7, after BIDP system 190 refreshes the tables in BIDR database 156 and AP database 154, BIDP system 190 may generate one or more output BIDPs (step 760). In one embodiment, BIDP system 190 may gather data from data tables in BIDR database 156 and generate a data table when requested by the user.

For example, the user may request that BIDP system 190 generate an output data table showing the number of patents and other technical papers related to the products for the buyer company and seller company of a merger. The user may further request that the output data table contain links to the supporting patent and technical/business documents. Further, the user may request that the output data table illustrate products in the context of product families.

BIDP system 190 may require the user to specify the data table format, such as the column widths of the data table and how the hyperlinks may be displayed in the data table (e.g., underlined or not). Once BIDP system 190 receives the specification for the output format, it may generate the requested output BIDP.

FIG. 9 shows an exemplary output BIDP 900 consistent with certain disclosed embodiments. As shown in FIG. 9, BI data presentation 900 shows the patent and technical/business publications related to the products of the buyer and seller parties to a merger/acquisition. In the exemplary data model shown in FIG. 8, BIDP system 190 may generate BIDP 900 based on data from various dimension tables, such as product family table 850 and fact table 810.

In the example shown in FIG. 9, company A (910) is the buyer company with three main products in technical area A (930). Company B (920) is the seller company with two main products in technical area A (930). Technical area A (930) may be further divided into two sub-areas: category A (940) and category B (950). Categories A and B may further be divided into six sub-categories: classes I-VI (i.e., 941, 942, and 951-954). The five products of company A (910) and company B (920) require technologies in all sub-areas and sub-categories of technical area A (930).

As shown in FIG. 9, for product 1, company A has obtained four U.S. patents and published two technical papers (943) in the technical area labeled as class I (941). For product 1, company A has obtained two U.S. patents and published one paper in the technical area labeled as class II. Further, data fields of BIDP 900, such as 943, may contain links to the patents and technical papers represented in the data field.

Based on BI presentation 900, company A (910) may note that it has not procured any patents or published any papers in the technical area labeled as class IV (952). Company A (910) may observe that company B (920) has patents and publications in that technical area. This may indicate to company A (910) that company B (920) may be an attractive merger target from this aspect.

Methods and systems consistent with the disclosed exemplary embodiments may be used together with other software programs to provide online analysis of BI data. For example, BIDP system 190 may be implemented to collect BI data related to a specific technical area in real time and present the BI data in various output data aggregation formats. The BI data presented may incorporate both patents and technical/business-related BI information for the interested technical area.

The disclosed embodiments may be implemented to present BI data reflecting information for supply chain management, merger and acquisition, and other business management processes and transactions. For example, BIDP system 190 may be implemented to collect BI data related to one or more acquisition targets. BIDP system 190 may generate one or more BI data presentations related to the one or more acquisition targets to illustrate the estimated value of intellectual assets for each of the acquisition targets.

The disclosed embodiments may also be implemented to assess potential legal damages in a certain technical area. A business may implement BIDP system 190 to collect BI data related to various product families. BIDP system 190 may be implemented to generate BIDP illustrating past legal damages awarded in litigations related to patents concerning the product families.

It will be apparent to those skilled in the art that various modifications and variations can be made in the disclosed exemplary embodiments without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

1. A system for generating a business intelligence data presentation, comprising:
a memory to store program code; and
a processor to execute the program code to perform a process for generating the BI data presentation, the process comprising:
collecting BI data from one or more data sources;
verifying the collected BI data;
defining an output presentation format in a multidimensional BI database;
loading the collected BI data into the multidimensional BI database;
refreshing data tables in the multidimensional BI database based on the loaded BI data; and
generating an output BI data presentation based on the loaded BI data and the output presentation format.

2. The system of claim 1, wherein the multidimensional BI database includes a fact table and one or more dimension table.

3. The system of claim 2, the process further comprising:
determining a BI data category for the collected BI data; and
verifying the collected BI data based on the BI data category.

4. The system of claim 2, the process further comprising:
receiving one or more presentation criteria; and
indexing the collected BI data based on the one or more presentation criteria.

5. The system of claim 4, the process further comprising:
receiving one or more edits for the indexed BI data; and
determining synonymous terms based on a data value associated with one of the presentation criteria.

6. The system of claim 5, the process further comprising:
organizing the collected BI data based on the synonymous terms.

7. The system of claim 6, the process further comprising:
associating the output presentation format with one or more tables in the multidimensional BI database; and
mapping the collected BI data into the one or more tables associated with the output presentation format.

8. The system of claim 7, wherein the output presentation format is defined based on one or more data fields of the fact table and the one or more dimension tables in the multidimensional BI database.

9. A method for generating a business intelligence data presentation, comprising:
performing a process for generating the BI data presentation through an interaction of a user with a BI data presentation architecture, the process including:
collecting BI data from one or more data sources;
verifying the collected BI data;
defining an output presentation format in a multidimensional BI database;
loading the collected BI data into the multidimensional BI database;
refreshing data tables in the multidimensional BI database based on the loaded BI data; and
generating an output BI data presentation based on the loaded BI data and the output presentation format.

10. The method of claim 9, wherein the multidimensional BI database includes a fact table and one or more dimension tables.

11. The method of claim 10, the process further comprising:
determining a BI data category for the collected BI data; and
verifying the collected BI data based on the BI data category.

12. The method of claim 10, the process further comprising:
receiving one or more presentation criteria; and
indexing the collected BI data based on the one or more presentation criteria.

13. The method of claim 12, the process further comprising:
receiving one or more edits for the indexed BI data; and
determining synonymous terms based on a data value associated with one of the presentation criterion.

14. The method of claim 13, the process further comprising:
organizing the collected BI data based on the synonymous terms.

15. The method of claim 14, the process further comprising:
associating the output presentation format with one or more tables in the multidimensional BI database; and
mapping the collected BI data into the one or more tables associated with the output presentation format.

16. The method of claim 15, wherein the output presentation format is defined based on one or more data fields of the fact table and the one or more dimension tables in the multidimensional BI database.

17. A method for generating a business intelligence data presentation, comprising:
collecting BI data from one or more data sources;
establishing an output format for the BI data presentation in a multidimensional BI database;
populating data tables in the multidimensional BI database based on the collected BI data; and
generating an output BI data presentation based on the collected BI data and the output format.

18. The method of claim 17, further comprising:
indexing the collected BI data based on one or more presentation criteria; and
generating the output BI data presentation based on the one or more presentation criteria.

19. The method of claim 18, wherein the collecting includes collecting the BI data including patent data and nonpatent data.

20. The method of claim 19, wherein the generating includes generating output BI data presentation reflecting patent and nonpatent information in a technical area.

21. The method of claim 19, wherein the generating includes generating output BI data presentation reflecting patent and nonpatent information in relation to a product family with one or more products.

22. A system for generating a business intelligence data presentation, comprising:
a first database storing business data;
a second database storing technical data; and
a processor to execute the program code to perform a process for generating the BI data presentation, the process comprising:
determining a BI analysis goal and a BI data presentation format associated with the BI analysis goal based on data in the first database and in the second database;
determining a presentation criterion associated with the BI presentation format;
organizing the technical data in the second database based on the presentation criterion;
organizing the business data in the first database based on the presentation criterion; and
generating an output BI data presentation based on the BI data presentation format and the organized technical data and business data.

23. The system of claim 22, wherein the determining the presentation criterion includes:
determining the presentation criterion based on a first keyword and a first weight associated with the first keyword.

24. The system of claim 23, wherein the determining the presentation criterion includes:
determining the presentation criterion based on a second keyword and a second weight associated with the second keyword.

25. The system of claim 22, wherein the presentation criterion is associated with one or more of the following criteria:
one or more products, one or more technologies, one or more fields of use, one or more product applications, one or more product margins, one or more supplier relationships, one or more processes, one or more product-by-processes, one or more technical documents, one or more business documents, one or more prior art references, one or more prior art citations, and one or more citing patents.

26. The system of claim 23, wherein the presentation criterion is further associated with one or more of the following criteria:
frequency of prior art citations, one or more patent classes, one or more patent subclasses, one or more related patent applications, one or more related issued patents, one or more corresponding foreign patent applications, one or more corresponding foreign issued patents, one or more patent application filing dates, one or more patent issue dates, one or more patent claims, one or more pending patent application claims, one or more issued patent claims, one or more patentees, one or more inventors, one or more authors, one or more patent assignments, one or more patent application assignments, one or more assignors, one or more assignees, one or more licensors, one or more licensees, one or more license agreements, one or more competitors, one or more infringers, one or more litigations, one or more litigation parties, one or more patent annuity payment due dates, one or more patent maintenance payment due dates, one or more bill of materials, sales data, one or more publications, one or more product trademarks, one or more trademark licenses, one or more service marks, one or more service mark licenses, one or more copyrights, one or more copyright licenses, one or more trade secrets, one or more trade secret licenses, know-how, one or more know-how licenses, one or more mergers, one or more acquisitions, one or more transfers of ownership, one or more corporate entities, and one or more transfers of licenses.
